(19) United States
(12) Patent Application Publication
(10) Pub. No.: US 2014/0081595 A1
(43) Pub. Date: Mar. 20, 2014

(54) GRAVITY GRADIOMETER SURVEY TECHNIQUES

(71) Applicants: Jeremy White, Cambridge (GB); Richard James Foster-Turner, Cambridge (GB); Gary Barnes, Cambridge (GB); Phillip Houghton, Cambridge (GB)

(72) Inventors: Jeremy White, Cambridge (GB); Richard James Foster-Turner, Cambridge (GB); Gary Barnes, Cambridge (GB); Phillip Houghton, Cambridge (GB)

(73) Assignee: ARKeX Limited, Cambridge Cambridgesshire (GB)

(21) Appl. No.: 14/006,174

(22) PCT Filed: Mar. 12, 2012
(86) PCT No.: PCT/GB2012/050540

§ 371 Date: Dec. 3, 2013

(30) Foreign Application Priority Data
Mar. 21, 2011 (GB) 1104687.7

(51) Int. Cl. G01V 7/06

(52) U.S. Cl. CPC G01V 7/06
USPC 702/154

(57) ABSTRACT

We describe improved techniques for airborne gravity gradiometer surveys. In particular we describe a method and system for performing a gravity gradiometer survey of a surveyed region of terrain, the method comprising: providing an aircraft with a gravity gradiometer; flying said aircraft over said terrain at a speed of at least 100 m/s and at an average height above said terrain of above said terrain of at least 300 m; and collecting gravity gradient data for said surveyed region of terrain from said gravity gradiometer, said gravity gradient data comprising data for at least one component of the gravity gradient tensor.

### FIELD OF THE INVENTION

This invention relates to improved techniques for airborne gravity gradiometer surveys.

### BACKGROUND TO THE INVENTION

A potential field survey is performed by measuring potential field data which, for a gravity survey, may comprise one or more of gravimeter data (measuring gravity field) or gravity gradiometer data (measuring gravity field gradient), vector magnetometer data, true magnetic gradiometer data, and other types of data well-known to those skilled in the art. A common aim of a geophysical potential field survey is to search for signatures which potentially indicate valuable deposits such as minerals or hydrocarbons. Background prior art can be found in: US2007/010946; US2002/092350; and US2009/000784.

A gravity gradiometer measures gravity gradient and should not be confused with a gravimeter. As well as measuring different things, these instruments have different noise spectral responses. In general it is desirable to obtain the most accurate survey data possible, and for both types of survey this has led to attempts to fly ‘low and slow’ over the surveyed terrain, with a tight line spacing. This is motivated in part by the observation that, for the majority of noise and error spectra, better results are obtained when flying a single survey line by flying slowly. Flying low is motivated by the observation that the high frequency signal falls off exponentially with height above the surveyed terrain.

The inventors have realised, however, that contrary to prevailing thought, there is a set of parameters for which good quality data can be obtained with an entirely different approach.

### SUMMARY OF THE INVENTION

According to the present invention there is therefore provided a method of performing a gravity gradiometer survey of a surveyed region of terrain, the method comprising: providing an aircraft with a gravity gradiometer; flying said aircraft over said terrain at a speed of at least 100 m/s and at an average height above said terrain of at least 300 m; and collecting gravity gradient data for said surveyed region of terrain from said gravity gradiometer, said gravity gradient data comprising data for at least one component of the gravity gradient tensor.

Broadly speaking, the inventors have recognised that flying fast and high can provide technical advantages by, in effect, shifting the geological signal to higher frequencies. Thus, more particularly, flying fast effectively shifts long wavelength signals, which can be larger in amplitude, to a shorter wavelength/higher frequency region for effectively no change, or depending upon the instrument a reduction in background noise. In embodiments the aircraft is flown at a speed of greater than 150 m/s or greater than 200 m/s. In embodiments the aircraft is flown at a minimum height of at least 300 m; the minimum or average height flying height may be at least 400 m, 500 m, 600 m, 700 m, 800 m, 900 m, 1 km, 1.5 km or 2 km. The gravity gradiometer may measure one, some, or all of the tensor components of the gravity gradient tensor (in the latter case it may be referred to as a full tensor gravity gradiometer), using one or more sensors (one sensor may measure more than one gravity gradient component).

There is also a synergistic effect of flying higher when surveying with large line spacing. In embodiments the average spacing of lines is at least 300 m, 400 m, 500 m, 600 m, 700 m, 800 m, 900, or 1000 m. Thus in some preferred embodiments, the flight height is designed to be greater than the line spacing. Preferably the average height of the survey is at least twice an average spacing of the survey lines (and/or along a line the height of the line above the terrain at that point is at least twice the spacing to the next nearest line). Two different types of aliasing can arise in a survey according to an embodiment of the method: aliasing along a line arising from effectively moving the spatial frequency power to a higher temporal frequency, in combination with the instrument bandwidth; and aliasing between lines when these are widely separated. Flying high addresses both these potential problems. In embodiments of the method the gravity gradiometer has a temporal bandwidth extending up to an upper frequency (3 dB point) of at least 0.1 Hz, 0.18 Hz, 0.2 Hz, 0.5 Hz, 0.7 Hz or 1 Hz.

Embodiments of the above described methods also take advantage of the observation that the signal spectrum from typical geologies has a higher signal power density at long spatial wavelengths and, in general, a smaller signal density at shorter spatial wavelengths. Thus the combination of, broadly speaking, flying fast, flying high, and employing wide line spacing defines an unexpected, synergistic region in the operational space of a gravity gradiometer survey.

In some preferred embodiments the surveyed region is also relatively large, for example having a minimum lateral dimension of at least 50 km, 100 km or 150 km. Such a ‘regional style’ survey in effect increases the signal-to-noise ratio by accentuating the longer wavelengths, which are effectively temporally compressed and shifted to higher frequencies) where a better signal-to-noise ratio is present. The upper end of the temporal bandwidth of the gravity gradiometer, the shortest geological wavelength of interest, and the speed of the aircraft are related in that (absent other constraints such as safety) the optimum speed of the aircraft, v, is defined by a product of the shortest wavelength of interest (λₘᵢₙ) and upper frequency of the instruments' temporal bandwidth (fᵤₚₚₑᵣ). Thus these parameters may be Bused to define a speed for the aircraft, though in reality the maximum safe speed (depending upon the other considerations) may be less than that defined by the bandwidth limit of the instrument. Thus in embodiments, v satisfies v≧B×fᵤₚₚₑᵣ·λₘᵢₙ where B is at least 0.5, 0.6, 0.7, 0.8, 0.9 or 1.0.

In embodiments of the method data from the gravity gradiometer is collected concurrently with data from a gravimeter. Gravity data from a gravimeter is affected by high frequency noise (for example resulting from movement a platform on which the gravimeter is placed). More generally the noise of a gravimeter increases with increasing frequency, which suggests that it would be disadvantageous to collect gravimeter data according to embodiments of the above described method. However, particularly when combined with a potential field survey which extends over a large region and/or has wide line spacing, the gravimeter data is useful and can be complementary to the gravity gradiometer data. This is, broadly speaking, because the gravimeter data can provide an improved signal-to-noise ratio for long wavelength signals (i.e. from a large surveyed region and/or with a wide line spacing). Thus a combination of gravity data and gravity gradiometer data can provide an overall improvement in signal-to-noise ratio when flying fast and high, especially with large surveys with a wide line spacing because broadly speaking, the low noise level of the gravimeter at long wavelengths compliments the effect of shifting the overall signal spectrum from the geology up in frequency to where the gravity gradiometer performs best.

Where gravity data is combined with gravity gradiometer data, it is preferable to process the data together, again to provide synergistic modelling of the surveyed terrain. More particularly in some preferred approaches, the gravity data and gravity gradiometer data are processed by generating a model of the surveyed region (which model may comprise a set of field mapping parameters mapping the gravity field, for example a set of parameters of an equivalent source model), and then a prediction of this model of this surveyed region is fitted to the collected gravity data and gravity gradient data. In this process the fitting takes account of the bandwidth and/or noise spectrum of either or both of the gravity data (gravimeter) and the gravity gradient data (gravity graviometer). For further details of such techniques reference may be made to the applicants published PCT application WO2010/130967, hereby incorporated by reference.

In general the noise spectrum of the gravity gradiometer is shaped, and in some preferred embodiments of the method this shape is used to determine the speed of the aircraft. More particularly the speed may be selected to maximise the signal-to-noise ratio (SNR) of the geological gravity gradient signal (subject to safety constraints), or to at least to increase this SNR. Thus in embodiments of the method the speed of the aircraft is selected dependent on a difference of the noise level of the gravity gradiomter and a gravity gradient signal for the surveyed region over a frequency range for which the gravity gradiometer survey is to be performed (that is the range of temporal frequencies which correspond to the desired range of spatial frequencies for which the geological survey is to be conducted, the temporal frequencies themselves being dependent on the speed of the aircraft).

In some preferred embodiments, the gravity gradiometer data (optionally in conjunction with the gravimeter data) is analysed taking into account a time-domain terrain correction. More particularly in embodiments this comprises determining a set of gravity field mapping parameters using a model comprising a combination of a spatial part representing a spatial variation of the gravity field, and a temporal part representing time domain noise in the collected data. The gravity field mapping parameters (for example a set of the equivalent source parameters) may then be determined by fitting the collected data with both the spatial part and the temporal part of the model. Further details of such techniques, which may be synergistically employed to the data collected by the approaches described herein, can be found in our PCT application WO2008/117081, hereby incorporated by reference. Optionally, the techniques we describe in WO2008/093139 may also be applied.

The method is particularly advantageously applied to a gravity gradiometer which exhibits an increase in noise level with decreasing frequency, for example one which exhibits “red” or “1/f” type noise. An example of such a gravity gradiometer is our EGG superconducting gravity gradiometer, for example as described in Lumley et al, “A superconducting gravity gradiometer tool for exploration” (2004), ASEG-PESA Airborne Gravity Workshop, Sydney. More generally, such “red” noise is often observed in SQUID-based superconducting gravity gradiometers. Thus in embodiments the techniques we describe can be thought of as shifting the geological signal up in frequency, and hence away from an increasing noise floor. However advantages of the techniques we describe are not limited to instruments in which the noise floor falls with increasing (temporal) frequency: Advantages can also be obtained, for example, with instruments in which the noise floor over the frequency range of interest is substantially flat.

The invention also provides a computer system programmed to analyse the collected gravity gradient data, optionally in conjunction with the gravimeter data, from a survey as described above, using the analysis techniques described above. The invention also provides corresponding processor control code on a carrier such as a computer disc or programmed memory. The computer processing system may comprise: data memory for storing measured potential field data and plot and/or model data for representing the underlying geology of the surveyed region, program memory storing processor control code to implement the analytical portions of a method as described above; and a processor coupled to said data memory and to said program memory to load and implement said control code.

The invention further provides a physical data carrier, in particular in the form of a computer readable medium, carrying airborne flight survey data for performing a gravity gradiometer survey as described above, the flight survey data defining a flight pattern for the aircraft which comprises flying the aircraft over the surveyed region of the terrain at a speed of at least 100 m/second and at an average height above the terrain of at least 300 m. Optionally the flight survey data may also define that the lines of the flight survey have an average spacing of at least 300 m, 400 m or 500 m. Preferably the average height is at least 1×, 1.5×, or 2× an average spacing of the lines. The surveyed region may, in some preferred embodiments, have a dimension of at least 50 km, 100 km, 150 km or 200 km.

In a related aspect the invention provides system for performing a gravity gradiometer survey of a surveyed region of terrain, the system comprising: an aircraft provided with a gravity gradiometer and a data processor to store or transmit collected gravity gradient data from said gravity gradiometer for said surveyed region of terrain; and a data analysis system to analyse said collected gravity gradient data; and wherein one or both of said data processor and said data analysis system store collected gravity gradient data from flying said aircraft over said terrain at a speed of at least 100 m/s and at an average height above said terrain of at least 300 m.

In some preferred embodiments of the above described techniques, the aircraft is a jet aircraft.

In principle the aspects and embodiments of the invention described above may be applied to other forms of potential field survey, and thus the invention also contemplates substituting the aforementioned gravity gradiometer with an alternative potential field survey instrument, for example a magnetic potential field survey instrument such as a vector magnetometer.

### BRIEF DESCRIPTION OF THE DRAWINGS

These and other aspects of the invention will now be further described, by way of example only, with reference to the accompanying figures in which:

FIGS. 1a and 1b show, respectively, curves of gravity gradient (Gzz, arbitrary range in E/√Hz) at different flying speeds (100, 110), gravity field strength (gz in mGal/√Hz; 130), gravity gradiometer noise (120; arbitrary range in E/√Hz), and gravimeter noise (140; in mGal/√Hz) against frequency (in Hz); and an aircraft with flight survey data, and an example of a data processing system; illustrating embodiments of methods according to the invention;

FIG. 2a shows the signal to noise ratio (SNR) along a survey line (60 m/s) flying over a wide bandwidth geological model for both gravity gradient Gzz and gravity gz;

FIG. 2b shows the power spectral density (PSD) impulse response (from a point source) as a function of spatial frequency for both gravity gradient Gzz and gravity gz;

FIG. 3 is a flowchart of the methodology used;

FIG. 4a is an illustration of a synthetic model having dimensions 150×150 km used to illustrate the methodology of FIG. 3;

FIG. 4b shows the gravity measurements to be expected from the model of FIG. 4a;

FIG. 5a shows the error distribution in the predicted gravity when calculated from an equivalent source model using only gravity gradient simulated measurements;

FIG. 5b shows the error distribution in the predicted gravity when calculated using both gravity gradient and gravity data;

FIG. 6a is a cross-section construction of a gradiometer along one axis;

FIG. 6b is a circuit diagram for the gradiometer of FIG. 6a; and

FIG. 7 shows a flow diagram of an example terrain correction procedure for use with an embodiment of a method according to the invention.

### DETAILED DESCRIPTION OF PREFERRED EMBODIMENTS

Broadly speaking we will describe a method and system for performing geophysical surveys, particularly gravity and gravity gradiometer surveys, with improved performance by aligning the qualities of the sensing instrument, the expected signals from the geology and the available speed of the aircraft, vehicle or vessel being used.

The signal spectrum from typical geologies is shaped, with higher signal density at large spatial wavelengths (low spatial frequencies) and generally smaller signal density at short spatial wavelengths (high spatial frequencies).

The noise spectra of sensing instruments are generally shaped. For example a gravimeter system including GPS correction generally has higher noise at high temporal frequencies and a gravity gradiometer may have higher noise at low temporal frequencies.

The spatial wavelength of the geological signal and the temporal frequency of a measurement are linked by the speed of the survey: V=fλ.

Although the geological signal generally falls at higher (spatial) frequencies, there can be important and valuable information contained in the high frequency signal. The figure that represents the ability of an instrument to measure the useful information in the signal is the signal to noise ratio, which generally varies with frequency (or wavelength). A high signal to noise ratio (>>1) implies that the signal is well measured, a low signal to noise ratio (<1) means that the signal is lost in the instrument or measurement noise.

Conducting a survey at higher speed will shift all of the spatial frequency signals from the geology to higher temporal frequencies in the measurement. For any measuring instrument that has lower noise at higher temporal frequencies, this may increase the signal to noise ratio in regions of the signal spectrum revealing otherwise hidden information.

Depending on the target geology and the purpose of the survey, sufficient signal to noise ratios may be obtained across enough of the signal spectrum that a faster survey can be performed at higher altitude. This tends to reduce further the geologic signal at high spatial frequencies (because of the properties of the gravity field), but the benefits of shifting the geological signals to high frequencies with higher speed can be obtained. There may also be the supplementary benefit of reduced turbulence at higher altitudes, for example at greater than 1000 ft, 2000 ft, or 3000 ft above terrain, resulting in overall improved performance from the survey. A further supplementary benefit is that at sufficient height “instrument flight rules” can be applied, which facilitates covering a large region to capture long wavelength data.

At low frequencies, the signal to noise ratio may be smaller than desired, if the instrument noise is too great at low frequency. Under these circumstances, a combination of instruments with different shape noise spectra can provide improved overall performance.

In addition a faster plane, such as a jet plane, can have other advantages that produce a lower effective instrument noise. These include a lower vibration environment from having smoother (quieter) engines (turbo fans rather than turbo props): Many instruments perform better in lower acceleration environments, particularly gravity gradiometers that, in general, do not completely reject acceleration signals. Both the linear and angular acceleration environment are different. There is also improved resilience to turbulence (due to generally larger, heavier aircraft and large wing area), which also results in a lower acceleration environment during normal operations. Using a jet also facilitates long-range use of the equipment on board.

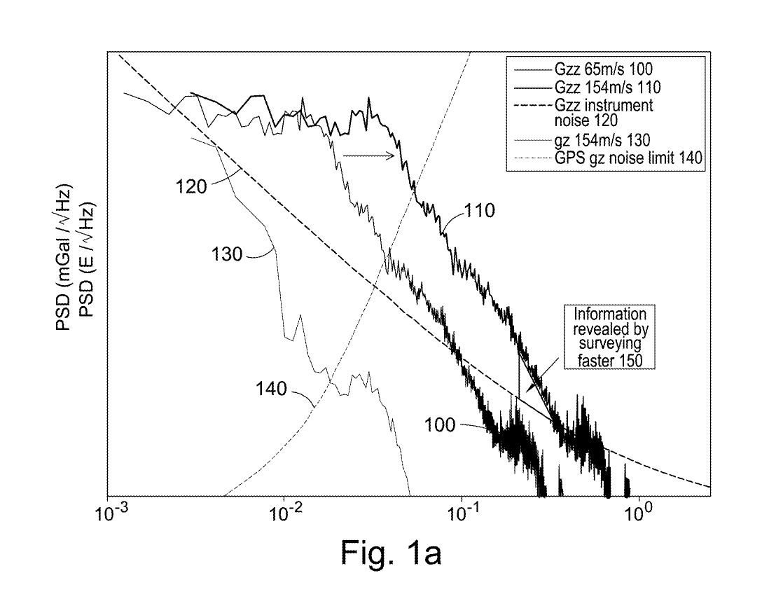

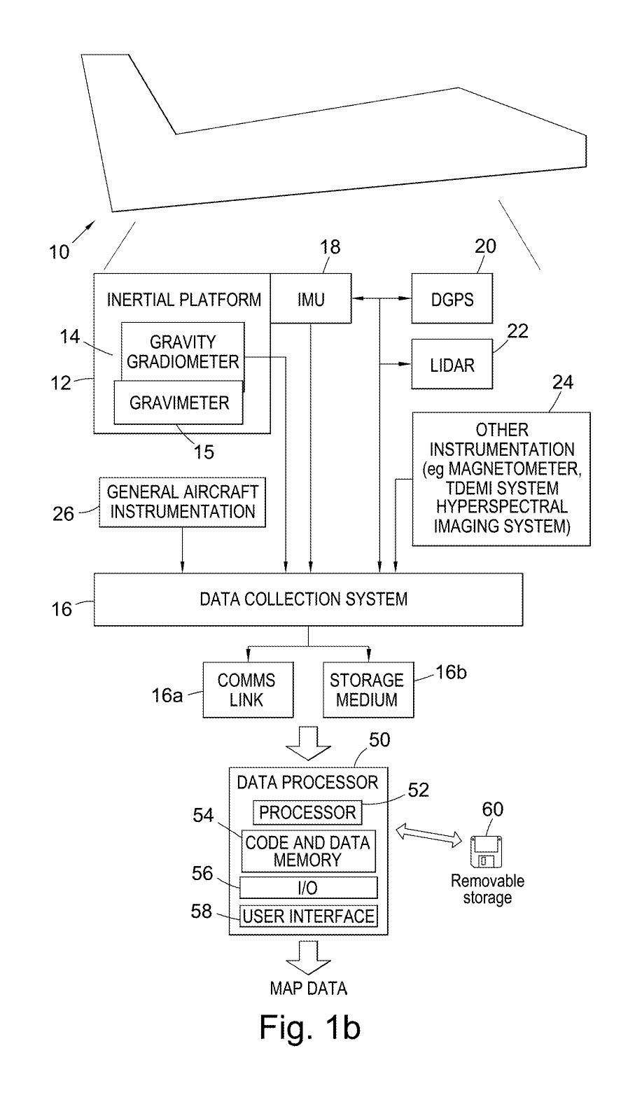

Referring now to FIG. 1a, this shows: A graph showing gravity gradient instrument noise dropping at higher frequencies (120); a graph showing typical geology gravity gradient signal dropping at higher frequencies (100); the shift of geology signal for different speeds (100 shifting to 110); a region 150 of improved signal-to-noise ratio; a graph showing shape of gravimeter system noise (140); and a graph showing gravity geology signal at high speed (130). There is a good signal to noise on gravity up to ˜2×10⁻² Hz, and a good signal noise on gravity gradient from ˜3×10⁻³ Hz to ˜0.3 Hz at high speed—so good overlap.

Thus it can be recognised that flying regional surveys, wide line spacing, flying fast and high all tie in together. Flying high is not only a consequence of flying fast, but also desirable since pushing more of the spatial frequency power to higher temporal frequency may cause aliasing problems (in particular with modulated systems with a small Nyquist limit). Flying higher attenuates exponentially more these higher frequencies therefore reducing the aliasing problems in low bandwidth instruments.

Flying fast also makes the “dynamic terrain correction” method (see below) more important. This is where the terrain correction is preferably done as a time domain calculation that follows the actual acquisition (x,y,z,t). Being in the time domain, the same transfer function (e.g. bandwidth) of instrument can be applied to the correction data therefore resulting in a better removal of the terrain signal as seen by the instrument. This can actually remove the majority of aliasing which would occur when gridding wide line spaced surveys (here the Nyquist wavelength is twice the line spacing) since most of the high frequency normally comes from the terrain. Removing in the time domain removes it before the spatial aliasing (which occurs when gridding), and hence better accounts for dynamic acquisition.

In choosing a speed, in embodiments the speed is ideally chosen so that the shortest geological wavelength of interest appears at the upper end of the useable temporal bandwidth of the instrument (this may be thought of as the most efficient use of the instrument).

However in practice safety and other constraints may limit the actual speed employed.

The v=fλ mentioned previously also applies to link the “shortest geological wavelength of interest” with the “upper end of temporal bandwidth”. So v_{survey}=fᵤₚₚₑᵣ×λₘᵢₙ−this speed will, in an ideal case, optimise the high frequency or short wavelength recovery.

The shortest geological wavelength of interest is determined by the target geology and terrain and might range from 50 m up to 1 Km depending on circumstances. However for the large-scale or regional surveys with which we are particularly concerned here the shortest geological wavelength of interest, λₘᵢₙ, may be in the range 300 m to 1000 m (400 m, 500 m, 600 m, 700 m, 800, 900, or 1000 m; in embodiments flying height is at least twice this). The upper end of temporal bandwidth depends on the instrument in use—there may be “hard-wired” constraints, for example related to sampling rates or modulation rates within the instrument (e.g. Lockheed Martin FTG with a Nyquist frequency 0.5 Hz) and/or there may be practical limits where noise starts to rise again for other reasons (e.g. resonances within the gravity gradiometer at, perhaps, 1-10 Hz) beyond which the data would be degraded again by higher speed.

Thus broadly, in choosing a speed in embodiments the speed is ideally chosen to maximise SNR of expected geological signal using a model of the frequency distribution of the instrument noise. This may be a generic optimisation (rather than seeking the recovery of particular high frequency or short wavelength information). In embodiments integration over frequencies to maximise the information recovered can be employed.

The noise model for an example gravity gradiometer is generally flat up to a cut-off of around 0.25 to 0.4 Hz—in which case the benefit is limited (but not zero). However a superconducting gravity gradiometer noise is “red”, or generally “1/f” (1/f in power, or 1/√f in amplitude as shown on the graph of FIG. 1a) which is typical of SQUID based and many unmodulated systems.

A preferred flying height is >1000 feet, although some benefit may be obtained with lower heights, for example >700 ft, >800 ft, or >900 ft.

### Combining Gravity Gradient and Gravity Data

In some preferred embodiments gravity gradient data and gravity data are combined, and processed in combination. We now describe one example of how this may be achieved.

FIG. 1b shows an example of an aircraft 10 for conducting a potential field survey to obtain data for processing in accordance with a method as described below. The aircraft 10 comprises an inertial platform 12 on which is mounted a gravity gradiometer 14 and a gravimeter 15 which both provide potential field survey data to a data collection system 16. Alternatively, the functionality of the gravimeter and gravity gradiometer may be incorporated into a single measuring instrument which is configured to measure both gravity and gravity gradiometry.

The inertial platform 14 is fitted with an inertial measurement unit (IMU) 18 which also provides data to data collection system 16 typically comprising attitude data (for example, pitch, roll and yaw data), angular rate and angular acceleration data, and aircraft acceleration data. The aircraft is also equipped with a differential GPS system 20 and a LIDAR system 22 or similar to provide data on the height of the aircraft above the underlying terrain. The aircraft 10 may also be equipped with other instrumentation 24 such as a magnetometer, TDEM system and/or hyperspectral imaging system, again feeding into the data collection system. The data collection system 16 also has an input from general aircraft instrumentation 26 which may comprise, for example, an altimeter, air and/or ground speed data and the like. The data collection system 16 may provide some initial data pre-processing, for example to correct the LIDAR data for aircraft motion and/or to combine data from the IMU 18 and DGPS 20. The data collection system 16 may be provided with a communications link 16a and/or non-volatile storage 16b to enable the collected potential field and position data to be stored for later processing. A network interface (not shown) may also be provided.

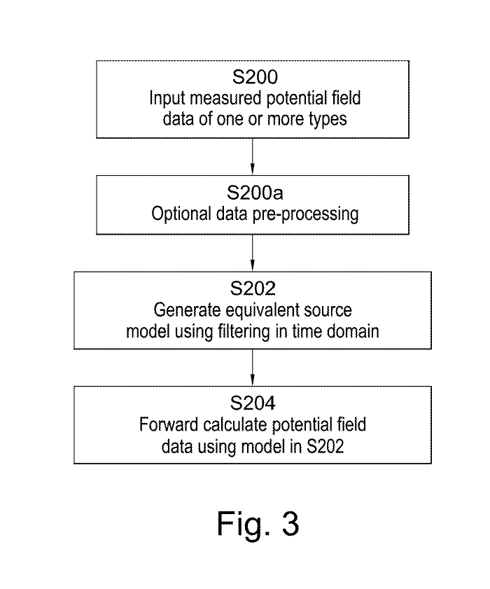

Data processing to generate map data for the potential field survey is generally (but not necessarily) carried out offline, sometimes in a different country to that where the survey data was collected. As illustrated a data processing system 50 comprises a processor 52 coupled to code and data memory 54, an input/output system 56 (for example comprising interfaces for a network and/or storage media and/or other communications), and to a user interface 58 for example comprising a keyboard and/or mouse. The code and/or data stored in memory 54 may be provided on a removable storage medium 60. In operation the data includes data collected from the potential field survey and the code comprises code to process this data to generate map data, for example in accordance with the procedure shown in FIG. 3, described below.

Consider an airborne potential field survey such as a gravity survey, flown on a grid pattern defined by orthogonal sets of parallel lines (flight paths) on a two-dimensional surface which is draped over the underlying terrain. When looking for underlying anomalies the nearby mass has a dominating effect and to provide an accurate representation of deep features a good representation of surface features is desirable so as to be able to perform terrain correction by subtracting-off particularly the higher frequencies (which dominate the power spectrum). A signal with wavelength λ falls off with height z as exp(−kz) where k=2π/λ (from which it can be seen that longer wavelengths are less attenuated) and the wavelength scale corresponds to a signature expected given a target's size and depth.

For gravity, the relevant potential is the gravity scalar potential, Φ(r), defined as

$$Φ ( r ) = \int \int \int \frac{G ρ ( {r}^{′} )}{\vert r - {r}^{′} \vert} {d}^{3} {r}^{′}$$

where r, ρ(r′), G are respectively, the position of measurement of the gravity field, the mass density at location r′, and the gravitational constant. The gravitational acceleration, which is how a gravitational field is experienced, is the spatial derivative of the scalar potential. Gravity is a vector in that it has directionality. It is represented by three components with respect to any chosen Cartesian coordinate system as:

$$g = ( {g}_{x} , {g}_{y} , {g}_{z} ) = ( \frac{\partial Φ ( r )}{\partial x} , \frac{\partial Φ ( r )}{\partial y} , \frac{\partial Φ ( r )}{\partial z} )$$

Each of these three components varies in each of the three directions and the nine quantities so generated form the Gravity gradient tensor:

$$G = ( \begin{matrix}{G}_{xx} & {G}_{xy} & {G}_{xz} \\ {G}_{yx} & {G}_{yy} & {G}_{yz} \\ {G}_{zx} & {G}_{zy} & {G}_{zz}\end{matrix} ) = ( \begin{matrix}\frac{\partial }{\partial x} \frac{\partial Φ ( r )}{\partial x} & \frac{\partial }{\partial x} \frac{\partial Φ ( r )}{\partial y} & \frac{\partial }{\partial x} \frac{\partial Φ ( r )}{\partial z} \\ \frac{\partial }{\partial y} \frac{\partial Φ ( r )}{\partial x} & \frac{\partial }{\partial y} \frac{\partial Φ ( r )}{\partial y} & \frac{\partial }{\partial y} \frac{\partial Φ ( r )}{\partial z} \\ \frac{\partial }{\partial z} \frac{\partial Φ ( r )}{\partial x} & \frac{\partial }{\partial z} \frac{\partial Φ ( r )}{\partial y} & \frac{\partial }{\partial z} \frac{\partial Φ ( r )}{\partial z}\end{matrix} )$$

Although there appear to be nine components of the gravity gradient tensor, there are only five independent components. Firstly, the tensor is symmetric as the order of differentiation of a scalar quantity does not matter (implying that G_{xy}=G_{yx}). Secondly, outside of the source, the sum of the diagonal terms equals zero (Laplace's equation). The ability to measure several spatially independent gravity components has obvious advantages over conventional gravity measurements, which only recovers the vertical component (G_{z})

There is a relationship between the depth (and shape) of a buried object and the wavelength (and amplitude) of the detected signal. In general, a measured quantity—say a component of the gravity vector or of the gravity gradient tensor will be a summation of the form shown below. Here we use gg as notation for the measured quantity, for example G_{zz}.

$${gg}_{calculated} ( {r}_{measure} ) = {\sum }_{all - masses}^{ } {m}_{mass - element} F ( {r}_{measure} - {r}_{mass - element} )$$

In the above equation F is called a Greens function (see for example, R. J. Blakely, “Potential Theory in Gravity and Magnetic Applications”, Cambridge University Press, 1995, at page 185, incorporated by reference) and rₘₐₛₛ₋ₑₗₑₘₑₙₜ defines the location of the mass element (for example the centre of mass or some other defined point).

The functions F are standard functions, essentially, the influence a source (mass element) of unity mass or density and defined shape would have at the relevant (measurement) point. The source may be a point source, sphere or ellipsoid but, in practice is more often a prism, which may be irregular. For example, if the presence of a particular geological layer or, say, geological anomaly, e.g. a kimberlite pipe, is suspected a shape can be defined to take account of this. A number of textbooks list Greens functions for simple shapes; functions for more complex source geometries can be found in the literature. Also the source influence superposes so that if a complex shape can be discretised into a plurality of simpler shapes then the Greens functions for the discrete shapes can be added together. This in principle allows numerical values for the Greens function of any arbitrary shape to be determined, although in practice relatively simple shapes are generally preferable. By way of example, the Green's function F for a rectangular prism (Blakely, ibid, at page 187), has 8 terms each of which corresponds to a vertex of the prism.

Airborne gravity gradiometry data is known to be of much higher resolution than conventional gravity data. This arises firstly because the power in the gradient signal is concentrated at higher spatial frequencies and secondly since the gradiometer, being a differencing instrument, is less sensitive to aircraft motion. The latter negating the need for heavy filtering of the data to suppress noise. Airborne gravimeters, intrinsically sensitive to aircraft motion, depend on filtering to reduce the noise to an acceptable level. Ultimately, the resolution of processed airborne gravity data is limited by the accuracy in which GPS derived acceleration corrections can be applied.

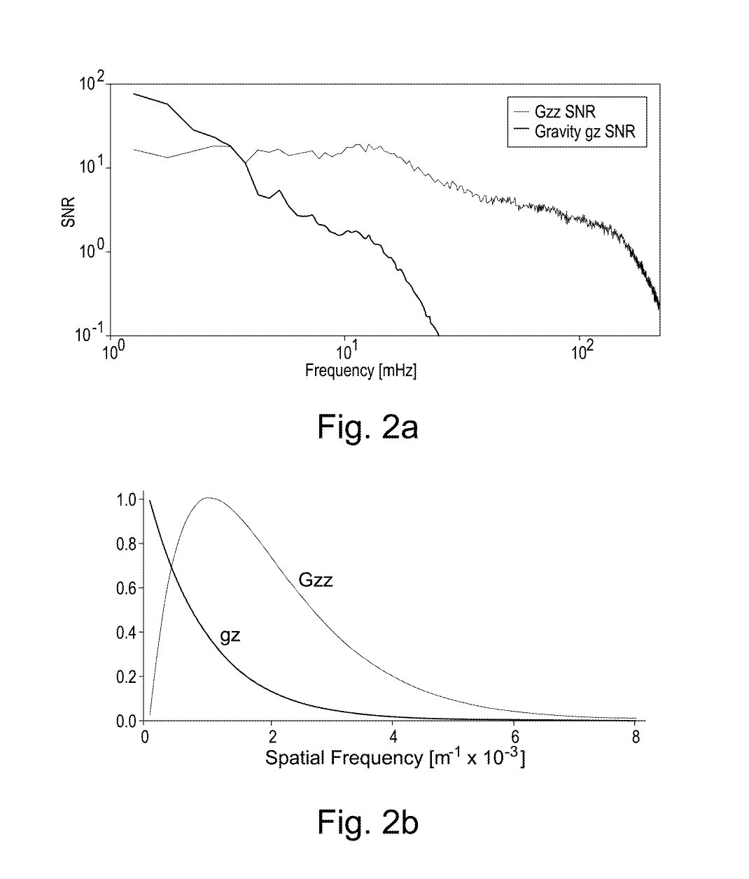

FIG. 2a shows the signal to noise ratio (SNR) of actual survey measurements for both gravity data gz and gravity gradiometry data Gzz. The gravity gradiometry data Gzz is deduced from Full Tensor Gradiometer (FTG) measurements resulting in a white noise level of 8 E/\Hz. The gravity data gz is deduced from airborne gravity measurements limited by GPS derived acceleration errors. The greyed out area highlights where the SNR is less than one and the signal is essentially lost in the noise. At higher frequencies (i.e. above 10 mHz) and thus at shorter wavelengths the gravimeter SNR deteriorates rapidly rendering the signals in this data with wavelengths less than 4 km unrecoverable. By contrast, the SNR for the gravity gradiometry does not deteriorate rapidly until after 100 mHz. Current gradiometer technology in commercial use (the FTG), measuring gradients with increased power in the high frequencies, allows the recovery of much higher resolution data down to 350 m.

Nevertheless as shown in FIG. 2b gravity data is also useful. FIG. 2b shows that the signal power spectral density (PSD) continues to increase with wavelength for gravity data whereas the PSD dramatically drops off for gravity gradient data from a spatial frequency below approximately 10⁻³ m⁻¹.

The turn over point for the gravity gradient data, where the signal power starts to decrease with decreasing frequency occurs at longer wavelengths than initially expected from the impulse response function shown in FIG. 2b. The example data of FIG. 2a shows that the Gzz SNR appears to go flat at low frequency for this geological signal. This maintenance of power is a result of the geological distribution of mass which tends to be correlated with a reddish spectrum therefore boosting the low frequency signal. For frequencies lower than those displayed in FIG. 2a, the gravity gradient power will however start to decrease and follow the impulse response of FIG. 2b. Nevertheless, for frequencies less than 3.5 mHz (equivalent to roughly 18 km), the gravity measurements start to offer greater SNR than the gravity gradient measurements.

To make optimum use of both sets of measurements, one should combine the long wavelength signals in the gravity measurements with the high bandwidth signals in the gravity gradient data. This will benefit regional style surveys (>100 km in extent) most noticeably where there is more bandwidth over which the gravity data is superior to the gravity gradient. For smaller surveys, the SNR within the gravity gradient measurements alone is sufficient to accurately image the entire bandwidth.

Referring now to FIG. 3 this shows an example of a procedure for implementing on a data processor which may, in embodiments, comprise a general purpose computer system, for processing data from a flight survey in accordance with the previously described techniques. Thus, at step S200 the procedure inputs the measured potential field data, e.g. from the gravity gradiometer and the gravimeter or from a combined instrument, together with other data, e.g. associated 3D position data. Optionally at step S200a, some pre-processing may be applied, for example to remove outliers and/or to select ranges of the data to be processed.

Because of the high level of acceleration noise that impinges on airborne gravimeters, the instruments tend to have an intrinsically low bandwidth to prevent saturation. Further, due to the poor accuracy in which GPS derived acceleration corrections can be applied at high frequencies, the recorded data tends to be heavily time domain filtered (>50 seconds). When combining gravity measurements with essentially unfiltered gravity gradient measurements, proper account needs to be taken of this filtering otherwise the gravity measurements will downgrade the high-resolution information in the gradients.

At step S202, the data is combined using an equivalent source inversion that is augmented with information regarding the measurement filtering to generate an equivalent source model. In this scheme, the standard equivalent source minimisation is augmented with a function that filters the predictions from the equivalent source model in the time domain to match the filtering and bandwidth of the measurements,

Minimise{∥Filter[Predictions(ρ)]−Measurements∥₂+regularisation(ρ)} (1)

where Filter is a time domain filter matching the filtering and bandwidth of the measurements, ρ is the density distribution of the equivalent source model which is to be solved to minimise the above functional and the fit measure is the standard least squares L₂ norm. Standard algorithmic methods can be applied to adjust the model parameters (i.e. the density distribution ρ) to achieve a minimum.

For the case of combining gravity and gravity gradient measurements, the filter ensures that the attenuated and distorted high frequencies in the gravity data do not compromise the more high-resolution gravity gradient data.

The equation also incorporates optional regularisation. With the correct choice of this regularisation and/or constraints, the resulting inversion can actually deconvolve the effect of the filtering and recreate bandwidth that was lost in the measurements.

After a successful inversion, at step S204, the model can be used to forward calculate gravity and gravity gradient components either back to the original measurement positions or at a series of new locations such as level grids for example. Such forward calculations proceed without the introduction of the filter matrices therefore providing the full bandwidth combination of all the measurement data. The forward calculated data may then be processed using any known technique, e.g. those taught in the applicant's earlier applications WO2007/012895, WO2007/085875, WO2008/093139, WO2009016348, WO2008117081 and PCT/GB2008/050041 which are herein incorporated by reference.

More details of the filter are provided for the case in which gravity and gravity gradient data is combined. The filter may be adapted as required to suit other types of data. The filter operates as a time domain convolution specifically for the pre-filtered gravity measurements. Representing (1) using matrix algebra results in

$$Minimise \{ {( [ \begin{matrix}F \\ I\end{matrix} ] ( [ \begin{matrix}{A}_{g} \\ {A}_{GG}\end{matrix} ] ρ ) - [ \begin{matrix}{m}_{g} \\ {m}_{GG}\end{matrix} ] )}^{2} + {{λ}^{2} ( R ρ - r )}^{2} \} \qquad ( 2 )$$

Here the matrices have been partitioned vertically to show how the gravity, m_{g} and gravity gradient, m_{GG} measurements are handled differently. A_{g} represents the superposition matrix of Green's function integrals that when multiplied by the source density vector ρ generates the set of gravity predictions from the model. In a similar way, A_{GG} ρ gives the gravity gradient predictions.

F is the filter convolution matrix that replicates the filtering already performed on the gravity measurements m_{g}. This commonly takes the form of a low pass filter, i.e. a filter that passes low-frequency signals but attenuates signals with frequencies higher than the cutoff frequency. Each row of F contains the weights that average together the predicted measurements from the source model. The gravity gradient model predictions in (2) are not filtered in this case and accordingly, the identity matrix I leaves them unchanged. Thus, the inversion uses only low frequency gravity data and full range gravity gradient data.

If parts of the gravity gradient data spectrum are known to suffer from extraneous noise, then a filter could be designed to remove this noise from the measurements and subsequently be built into the inversion as another filter matrix in place of I. The noisy part of this spectrum would not then compromise the inversion and the missing bandwidth would be made up by the gravity data.

A set of weights generating the effect of an exponential low pass filter with characteristic time T_{c} could be formed by the following

$${F}_{i , j} = \frac{{e}^{- ( {t}_{ij} / 0.5 {T}_{c} ) n}}{{\sum }_{j}^{ } {e}^{- ( {t}_{ij} / 0.5 {T}_{c} ) n}} \qquad ( 3 )$$

where t_{i,j} is the time between measurement points i and j and n is the filter order. For a first order filter (n=1), above the cut-off frequency, the signal amplitude is reduced by a factor e=2.718 every time the frequency doubles. A second order frequency attenuates higher frequencies more steeply.

Regularization is standard in these inversion problems, depicted in (2) by the matrix R and the vector r, can take many forms and aims to stabilise and control the solution. Common choices include Tikhonov regularization where λ controls the relative amounts in which the solution fits the data and a priori information specified by R and r (see for example Gravity Interpretation Fundamentals and Application of Gravity Inversion and Geological Interpretation Jacoby W., Smilde P. L, 2009, Springer, Berlin). Other forms of regularisation can attempt to smoothen the density distribution in space by making the matrix R a gradient operator.

The gravity and gravity gradient data is inverted into the same model described by the vector of parameters ρ. The minimisation (2) can be achieved using standard optimisation algorithms such as the conjugate gradient method or Monte Carlo methods (see for example: Numerical Recipes in C, 2^{nd} Edition, Press W.H., et. al. 1997, Cambridge University Press.)

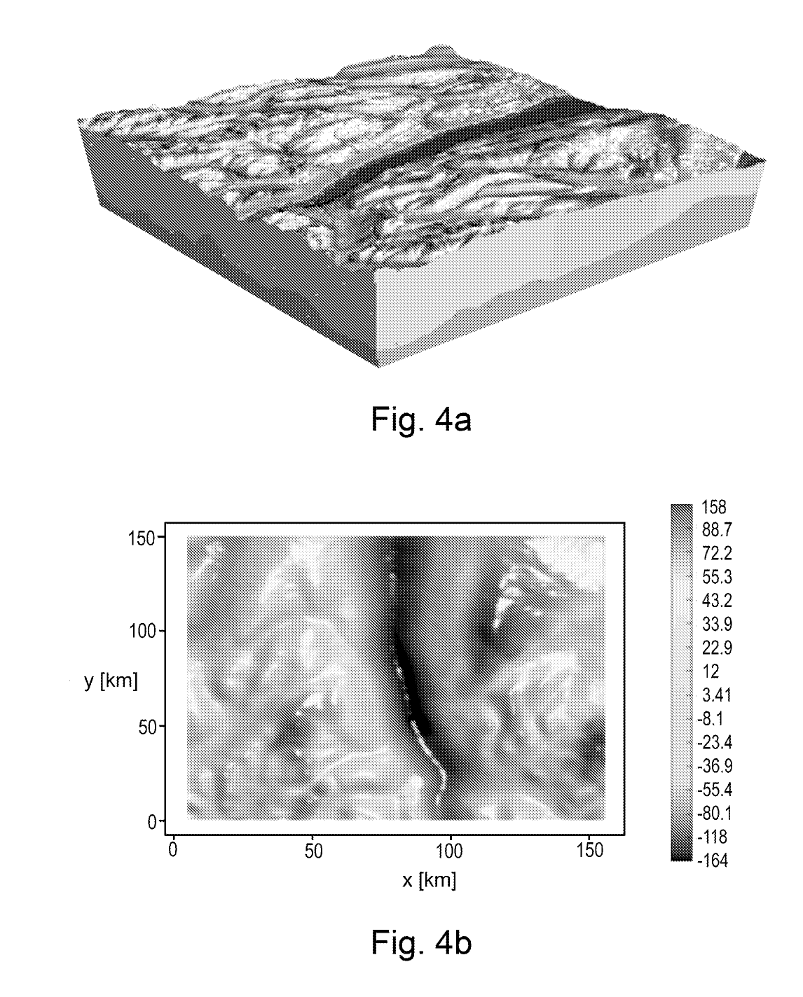

FIG. 4a shows a synthetic model having dimensions 150×150 km which was constructed to illustrate the advantages of combining gravity and gravity gradient data for a large survey. The model includes an approximately 200 km feature in the data which peaks along the y=x diagonal. Forward calculations from this model to a set of survey lines spaced at 5 km were performed to simulate the gravity and gravity gradient signals that would be measured during a survey. Noise appropriate to the instrumentation and data correction errors were added and subsequent filtering applied to get as close as possible to realistic measurement data. The expected gravity measurements as predicted by these calculations are shown in FIG. 4b.

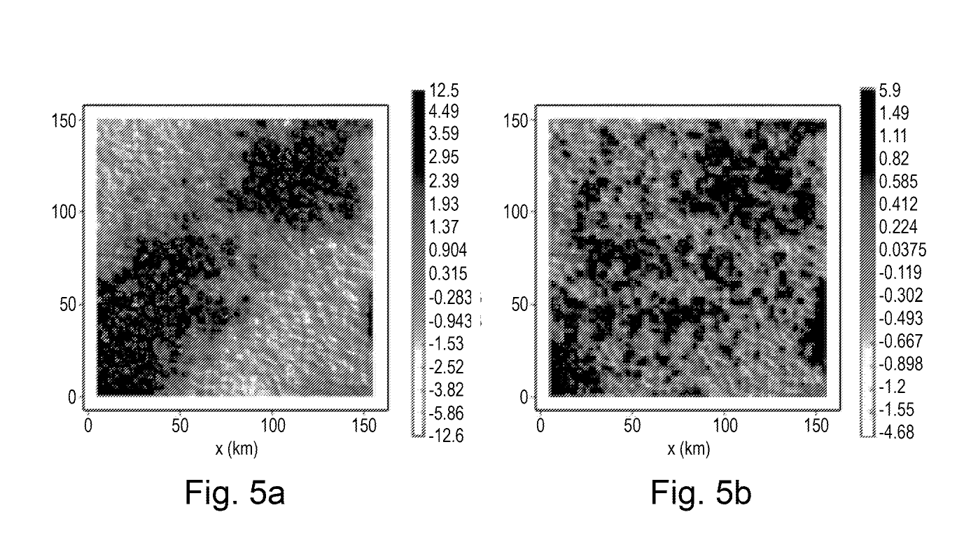

FIG. 5a shows the results of using only the simulated gravity gradient measurements in an equivalent source inversion. The resulting error distribution in the predicted gravity distribution is shown in FIG. 5a. Error plots of the predicted gravity gradient signals (not shown) reveal only small uncorrelated error distributions. The correlated nature of the gravity error highlights the deficiencies of accurate long wavelength signal in the gravity gradient measurements resulting in poor imaging of the 200 km feature peaking along the y=x diagonal.

FIG. 5b shows the results of incorporating the simulated gravity measurements into the inversion and shows the resulting gravity error distribution. As shown, the error in the gravity becomes essentially uncorrelated and lower in amplitude showing the benefit of combining the data with the filter augmented inversion as described above. The predictions of the gravity gradient fields after incorporating the gravity data remain essentially unchanged showing that the high-resolution part of the inversion is not distorted by the filtered gravity measurements.

In summary, the signal to noise ratio provided by gravity gradiometer surveys is adequate to provide an accurate complete picture of the geological signal for moderately sized surveys supporting wavelengths up to approximately 200 km. For larger regional style surveys, the lack of gradient signal power at low frequencies starts to compromise the recovery of the long wavelength geological features. To recover this missing part of the spectrum, equivalent source inversions combining gravity gradient and gravity measurements are used in an optimum way to yield superior results giving an accurate signal over a wide bandwidth. To correctly invert measurement sets that have undergone significant time domain filtering, the equivalent source inversion is augmented with information about the filter. In this way the inversion fits the measurements without distorting the actual inversion model. Such a model can then be used to predict high resolution signals without the affects of filtering.

The gravity and gravity gradient data sets can derive from separate survey systems acquired at different times or simultaneously from within the same system. In the latter case, the gravimeter and gradiometer may be mounted on the same stabilised platform (as shown in FIG. 1). Alternatively, gravity data can also be provided by a suitable output channel of a gradiometer.

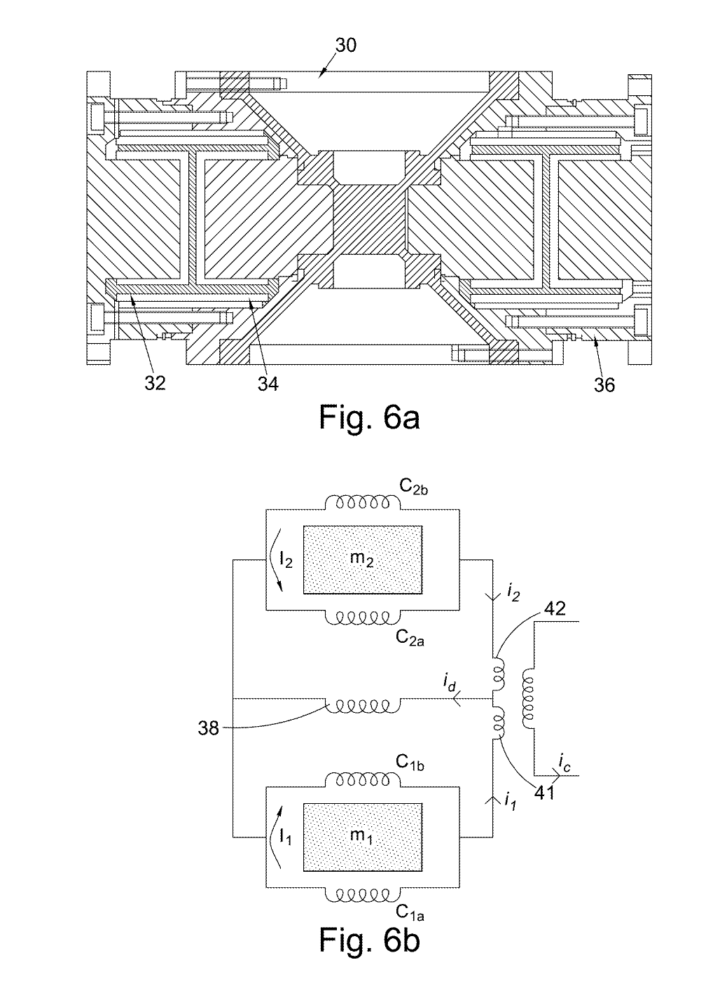

FIG. 6a shows two facing accelerometer modules making up a gradiometer comprising a pair of proof masses 32 with coils mounted on coil supports 34 acting on surfaces of the proof masses 32. Niobium sensor modules 36 monitor movement of the proof masses. The accelerometer is mounted in a titanium mounting cube 30. Between two and six accelerometer modules may be used in a gradiometer. FIG. 6a is taken from Lumley et. al., A superconducting gravity gradiometer tool for exploration (2004) ASEG-PESA Airborne Gravity Workshop, Sydney which describes the operation of the gradiometer in more detail and is here incorporated by reference.

As set out in the paper, it is helpful to consider what happens when the pancake coil-proof mass system is placed within a closed superconducting loop to understand the operation of the gradiometer. Understanding the operation is further complicated since there are two masses and two loops. Various schematic circuits are illustrated in the paper, with the preferred differential mode circuit shown in FIG. 6. The gradiometer described in the paper is designed to utilise the illustrated differential mode circuit to measure the gravity gradient signal. As explained in more detail below, it is possible to adapt such a gradiometer which has a principle form of operation revolving around differencing two or more acceleration measurements taken over a defined baseline to provide a common mode output which is a measure of linear acceleration. For example, in the case of an inline Gzz gradiometer that measures the vertical acceleration experienced at two points separated vertically, taking the difference of the two measurements provides for the gravity gradient whereas the common mode sum corresponds to the vertical acceleration. After conventional gravity corrections, processing, reduction and filtering, this common mode measurement provides the vertical gravity component. The differencing and summing stages are intrinsic to the gradiometer and are most effectively performed within suitably designed circuits that link the signals from each accelerometer module.

FIG. 6b illustrates one such suitably designed circuit which may be used in the gradiometer described in the paper to provide both gravity gradient signals and gravity signals. In the schematic of FIG. 6b there are two proof masses m₁ and m₂, each interacting with a pair of coils; (C₁ₐ, C_{1b}) and (C₂ₐ, C_{2b}). A first inductor 38 is connected to a first sensor (not shown) to measure the current passing through the inductor 38. A second sensor (not shown) is incorporated to measure the current i_{c} in an adjacent loop that couples to the main circuit through transformers 41 and 42. As explained in more detail below, the first sensor detects the gravity gradient and is operating in differential mode; the second sensor detects the gravity signal and is operating in common mode.

Both masses are supported by suspension structures which provide mass-on-spring type behaviour where the displacements of the proof masses are proportional to the total acceleration they experience. The proof masses and circuits are superconducting whereby persistent currents I₁ and I₂ can be stored and provide sensitivity to the proof mass displacements and thus their impinging accelerations. For example, if proof mass m₁ moves upwards towards coil C_{1b}, the inductance of coil C_{1b} will decrease and the inductance of coil C₁ₐ will increase. By applying the rules of flux conservation in superconducting loops, (e.g. as described in Lumley et. al. (2004)), such a change in coil inductances will cause a redistribution of currents resulting in a signal current commensurable with the proof mass displacement.

If the gradiometer is subjected to a change in gravity, this causes displacements of both proof masses in the same direction. Flux quantisation for each superconducting loop requires both i₁ and i₂ to change in the same direction (ie with the sign convention used in FIG. 6b, di₂=−di₁) and thus there is no change in the current flowing through the central arm of the circuit containing inductor 38. Thus a sensor coupled to this inductor measures no current i_{d} and does not see the common mode gravity signal. However, the response currents i₁ and i₂ both couple constructively through transformers 41 and 42 into the side loop forming a common mode current i_{c}.

In the presence of a gravity gradient, the gravitational acceleration at proof mass m₁ is different from that at proof mass m₂. In this case, the currents i₁ and i₂ change equally (di₂=di₁) resulting in a net current flowing through the central arm of the circuit which may be termed a differential mode response current i_{d}.

By monitoring currents i_{c} and i_{d} one therefore has simultaneous measures of gravity and gravity gradient changes from within the same sensor.

### Dynamic Terrain Correction

The largest amplitude and bandwidth signal in a gravity field survey almost always comes from the topography. Often in gravity field interpretation the terrain signal is removed by a terrain correction performed during a late stage of the data processing. However at this point, the time domain nature of the acquisition has been obfuscated since the data has been manipulated using spatial techniques. Thus in embodiments terrain correction may advantageously be performed in the time domain. We now describe one way in which this may be achieved (as described in more detail in our WO2008/117081, incorporated by reference).

Broadly speaking the method comprises inputting terrain data defining a spatial variation of terrain surveyed by the potential field survey, and determining time-domain correction data to be applied to said measured potential field data in the time-domain, using said terrain data and said data defining positions of the measurements as a function of time. The measured potential field data is adjusted using the time-domain correction data to provide terrain corrected measured potential field data for mapping the field. This may be performed on-line or off-line, after collection of the potential field data. The correction is, however, performed in the time-domain by means of a forward calculation from data in a terrain model database to the time series of measurement locations.

Preferably determining the time-domain correction data includes compensating for a bandwidth of the gravity gradiometer, for example by filtering the time-domain correction data using a filter matched to the response (eg an impulse response) of the instrument. This may comprise integrating measurements over an integration time interval dependent upon a response of the potential field measurement instrument. In embodiments the time-domain correction data comprises a set of calculated values of the measured potential field due to the terrain at three-dimensional positions in space along survey lines of the potential field survey. However in general these positions will not correspond to the actual recorded measurement positions. Instead preferably positions of the moving platform at regularly spaced intervals in time (and thus depend upon the speed of the moving platform). Thus, broadly speaking, the time-domain correction data comprises an effective component of the field measurement instrument data forward calculated from the terrain data at three-dimensional positions in space x(t), y(t), z(t) at substantially regularly spaced time intervals. This contribution to the potential field due to the terrain as a function of position in space of the moving platform at regular time intervals may then be subtracted from the actual potential field measurements to leave a signal of interest for further data processing, in particular due to underlying geological formations. Either or both of the actual, measured signal and terrain correction signal may optionally be extrapolated and/or interpolated so that corresponding data points substantially align for performing the correction.

Preferably the method further comprises determining a set of field mapping parameters mapping the field using the adjusted measured potential field data. There are many ways of achieving this including those mentioned in our earlier filed patent applications including, for example, our UK patent application GB2446174 (incorporated by reference).

By performing a terrain correction early on in the processing sequence, when the data is still represented in the time domain, one can ultimately produce a better map of the underlying geology because the terrain correction can be matched more closely to the data that was actually recorded by the instrument. In particular, the time domain correction will correctly remove high frequency terrain signals which would otherwise be aliased in spatial analysis. Also, by performing the correction in the same domain as the measurement system, the actual transfer function of the measurement instrument can be incorporated into the correction data. This means that the terrain correction is removing the effect the terrain has on the recorded measurement data rather than removing the terrain signal itself. This is important especially for airborne surveys flown at low altitude over highly variable terrain since the bandwidth of the measurement system can significantly alter the high frequency terrain signals.

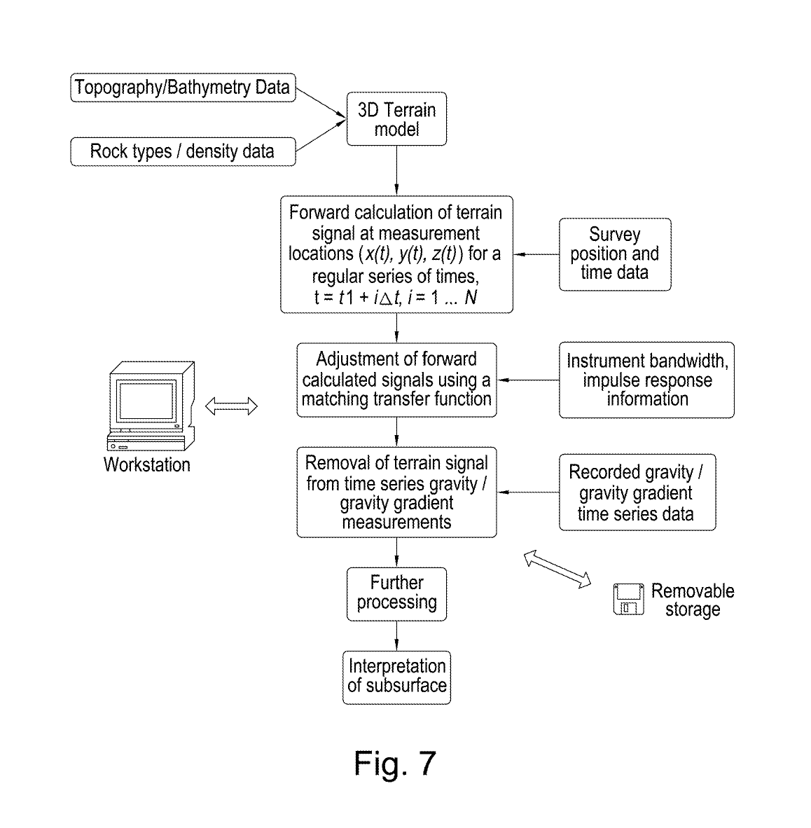

The preferred implementation of the time domain terrain correction system proceeds according to FIG. 7, which shows a flow diagram of steps involved in a preferred dynamic terrain correction; this procedure may be implemented in software on a carrier such as a disk, or in a computer system, as schematically illustrated.

The geometry of a 3D model of the terrain is constructed using available topography and bathymetry data. The assignment of density values within the model is guided by information originating from rocks types, well data or surface penetrating imaging techniques. The resolution of the model should be adequate to accurately recreate the surveyed potential field data from the terrain. Thus preferably the model has an extent which goes beyond the boundaries of the survey by a sufficient distance to render the contribution from terrain outside of the model negligible.

The terrain model is used to predict (forward calculate) the contribution that the terrain made to the total signal over the duration of the survey at a series of regular time intervals,

t=t1+iΔt (4)

where i is an integer and Δt is the calculation sampling time. Δt is chosen so that the resolution of the calculated terrain signal exceeds the measurement bandwidth of the instrument. For example, if the bandwidth is 0.5 Hz, the calculation sample time should be less than 1 second.

In practice, the terrain signal is calculated using the principle of superposition where the model is discretised into a set of finite volumes each of which having known mathematical functions to forward calculate the gravity field at a given set of field locations. The field points for these calculations are the locations (x(t), y(t), z(t)) and possibly the orientations (pitch, roll, yaw) of the instrument interpolated to the time series of equation (4).

The time series terrain forward calculated data is modified by means of a filter that is designed to mimic the response of the actual measurement. The design of this filter is accomplished by incorporating knowledge of the instrument bandwidth and its impulse response. An appropriate filter to perform this is a finite impulse response filter mathematically represented by a vector of filter coefficients. The filtered forward calculated terrain data then results by simple convolution with the filter.

The bandwidth matched terrain correction data is then resampled onto the time series of the recorded measurements and subtracted from them yielding a new set of raw measurement data ready for subsequent processing.

No doubt many other effective alternatives will occur to the skilled person. It will be understood that the invention is not limited to the described embodiments and encompasses modifications apparent to those skilled in the art lying within the spirit and scope of the claims appended hereto.

1. A method of performing a gravity gradiometer survey of a surveyed region of terrain, the method comprising:
providing an aircraft with a gravity gradiometer;
flying said aircraft over said terrain at a speed of at least 100 m/s and at an average height above said terrain of at least 300 m; and
collecting gravity gradient data for said surveyed region of terrain from said gravity gradiometer, said gravity gradient data comprising data for at least one component of the gravity gradient tensor.

2. A method as claimed in claim 1 wherein said flying comprises flying along a set of lines over said terrain, wherein an average spacing of said lines is at least 300 m, and wherein said average height is at least twice an average spacing of said lines.

3. A method as claimed in claim 1 wherein said surveyed region has minimum lateral dimension of at least, 50 km, 100 km, or 150 km.

4. A method as claimed in claim 1 further comprising determining a minimum geological gravity gradient signal wavelength of interest for said surveyed region, λₘᵢₙ, and wherein said speed of said aircraft, v, satisfies v≧B×fᵤₚₚₑᵣ·λₘᵢₙ where fᵤₚₚₑᵣ is an upper frequency of a temporal bandwidth of said gravity gradiometer, and where B is at least 0.5, more preferably at least 0.8.

5. A method as claimed in claim 1 further comprising determining a minimum geological gravity gradient signal wavelength of interest for said surveyed region, λₘᵢₙ, and wherein said speed of said aircraft, v, satisfies v≧fᵤₚₚₑᵣ·λₘᵢₙ where fᵤₚₚₑᵣ is an upper frequency of a temporal bandwidth of said gravity gradiometer.

6. A method as claimed in claim 1 further comprising providing said aircraft with a gravimeter, and collecting gravity data from said gravimeter for combining with said gravity gradient data from said gravity gradiometer.

7. A method as claimed in claim 6 further comprising generating a model of said surveyed region by fitting a prediction of a model of said surveyed region to said collected gravity and gravity gradient data, wherein said fitting models a bandwidth or noise of one or both of said gravity data and said gravity gradient data.

8. A method as claimed in claim 1 further comprising determining said speed of said aircraft from a noise spectrum of said gravity gradiometer.

9. A method as claimed in claim 8 wherein said determining of said speed of said aircraft increases or substantially maximises a difference between a noise level of said gravity gradiometer and a gravity gradient signal for said surveyed region over a frequency range for which said gravity gradiometer survey is to be performed.

10. A method as claimed in claim 1 wherein said gravity gradiometer has a temporal bandwidth extending up to an upper frequency of a least 0.1 Hz.

11. A method as claimed in claim 1 wherein said gravity gradiometer has a noise spectrum which exhibits a reduction in noise level with increasing signal frequency.

12. A method as claimed in claim 1 wherein said gravity gradiometer comprises a superconducting gravity gradiometer.

13. A method as claimed in claim 1, further comprising determining a set of gravity field mapping parameters using a model comprising a combination of a spatial part representing a spatial variation of said gravity field and a temporal part representing time domain noise in said collected data, and wherein said determining of said set of gravity field mapping parameters comprises fitting said collected data with both said spatial part and said temporal part of said model.

14. A non-transitory data carrier carrying airborne flight survey data for performing a gravity gradiometer survey from an aircraft provided with a gravity gradiometer, the flight survey data defining a flight pattern for said aircraft defining flying said aircraft over said terrain at a speed of at least 100 m/s and at an average height above said terrain of at least 300 m and collecting gravity gradient data for said surveyed region of terrain from said gravity gradiometer, said gravity gradient data comprising data for at least one component of the gravity gradient tensor.

15. A non-transitory data carrier as claimed in claim 14 wherein said flight survey data further defines a set of lines, wherein an average spacing of said lines is at least 300 m, and wherein said average height is at least twice an average spacing of said lines.

16. A non-transitory data carrier as claimed in claim 14 wherein said flight survey data further defines that said surveyed region has minimum lateral dimension of at least 50 km, 100 km, or 150 km.

17. A system for performing a gravity gradiometer survey of a surveyed region of terrain, the system comprising:
an aircraft provided with a gravity gradiometer and a data processor to store or transmit collected gravity gradient data from said gravity gradiometer for said surveyed region of terrain; and
a data analysis system to analyse said collected gravity gradient data; and wherein one or
both of said data processor and said data analysis system store
collected gravity gradient data from flying said aircraft over said terrain at a speed of at least 100 m/s and at an average height above said terrain of at least 300 m.

18. A system as recited in claim 17, wherein said aircraft is a jet aircraft.
